(19) United States
(12) Patent Application Publication
(10) Pub. No.: US 2006/0026794 A1
(43) Pub. Date: Feb. 9, 2006

(54) Handle apparatus

(76) Inventor: Kenneth Eugene Streetman, Gulfport, MS (US)

Correspondence Address: TERRY B. MORRIS, P.O. BOX 808, PASS CHRISTIAN, MS, 39571-0808, US

(21) Appl. No.: 11/104,128

(22) Filed: Apr. 12, 2005

Related U.S. Application Data
(60) Provisional application No. 60/599,344, filed on Aug. 6, 2004.

(51) Int. Cl. E05B 1/00

(52) U.S. Cl. 16/110.1

(57) ABSTRACT

This invention relates to a handle apparatus suitable for pulling wheeled or unwheeled devices by humans. The present invention provides a handle apparatus having a structure with attachment means to attach the handle apparatus to a subject device; a handle structure; and a structure between the attachment structure and the handle structure. The inventive device provides two or more degrees of freedom and enhances the ergonometric features of similar devices.

There is a co-pending provisional application for patenting, which is Application No. 60/599,344 having a filing date of Aug. 6, 2004.

There is no federally sponsored research or development relating to this application or patent issuing there from

### BACKGROUND

1. Field of the Invention

This invention relates to a handle apparatus, more particularly, an ergonometric handle apparatus suitable for pulling wheeled or unwheeled devices by humans.

Humans pull devices in a variety of activities. Often such activities subject the human anatomy to unwanted or undesired stresses; particularly when the device moves erratically or when it is pulled for extended time. For instance, humans pull luggage while traveling, such as rolling luggage through airports or hotel corridors. During such time the luggage may roll erratically, such as wobbling or bouncing. The handle for such luggage devices may be hinged handle midway on one side, such hinging offering only a nominal degree of freedom and intended merely to permit raising the handle from a storage position to a use position. Alternatively, the handle may be extended from its storage position close to the luggage box by a raised cantilever, typically to a locked, extended position for gripping and pulling of the luggage. While such luggage handle device designs represent improvements in the convenience of handling luggage or other devices, the human anatomy involved in the handling of such devices undergoes stresses, strains, fatigue and other undesired health consequences. Often the known handle device limits the load which a human could potentially pull without adverse consequences because the handle does not enable a maximum or enhanced gripping or pulling force. What is needed is an improved handle apparatus which addresses these concerns.

An object of the present invention is to provide a handle apparatus with increased degrees of freedom compared to known handle apparatus.

A further object is to provide a handle apparatus which design enables flexibility in the angle of stress and/or strain on the human anatomy during its use.

A further object is to provide a handle apparatus which design enables flexibility in the angle of the human hand relative to the arm and/or the arm relative to the shoulder to avoid or reduce fatigue in the human using the handle apparatus.

A further object is to provide a handle apparatus which design enables flexible redirection in the pulling force applied, such as to accommodate maneuvering of the pulled device in a curvilinear directing or in surface elevation change.

Yet a further object of the present invention is to provide a handle apparatus to enable a better (enhanced or optimal) gripping force in the relative configuration between the human anatomy and the device being pulled.

Yet a further object of the present invention is to provide a handle apparatus to enable a better (enhanced or optimal) pulling force in the relative configuration between the human anatomy and the device being pulled.

These and other objectives are achieved by the present invention disclosed herein.

2. Description of Related Art

Handle devices for luggage apparatus are disclosed in U.S. Pat. Nos. 6,711,784 B2; D489,181 S; and D492,486 S; as well as in Applications 2004/0079603 A1 and 2004/0124053 A1.

### BRIEF SUMMARY OF THE INVENTION

The present invention meets the above objectives by providing a handle apparatus having a structure with attachment means to attach the handle apparatus to a subject device; a handle structure; and a structure between the attachment structure and the handle structure. The inventive device provides two or more degrees of freedom.

### BRIEF DESCRIPTION OF THE DRAWINGS

FIG. 1 is an exploded view of a handle assembly embodying the present invention.

### DETAILED DESCRIPTION OF THE INVENTION

One embodiment of the present invention is a handle apparatus comprising a first structure comprising attachment means to attach said handle apparatus to a subject device; a handle structure; and a second structure communicating between said first structure and said handle structure, said second structure having means providing two or more degrees of freedom between said first structure and said handle structure.

Preferably the first structure comprises an elongated member with two ends. Attachment means are located proximal to each end. These attachment means are effective to attach the handle apparatus to an existing handle. For instance, an existing piece of luggage can have an existing handle at one of its end and a set of rollers at the other end has to permit pulling the luggage supported by the rollers on the surface over which the luggage is being pulled. This existing handle extends from the luggage because the arms of the handle (such as in a C-shaped handle) or the stem of the handle (such as in a T-shaped handle) are attached to the luggage box. Such extended handle of the luggage has a gripping member which is typically gripped by the human pulling the luggage. The present handle apparatus invention's first structure can be a pole or bar which is aligned parallel to this gripping member and the relative alignment position is then maintained by attachment means to secure the handle apparatus to the extended handle. Such attachment means can be any of a variety of effective means to secure the handle apparatus to the extended handle. Non-limiting examples are straps, such as Velcro material or elastic straps with a pin and corresponding hole, which can be secured to the first structure of the handle apparatus or looped around both the first structure and the extended handle. Alternatively, attachment means can be pins. These pins can be driven through both the first structure and the extended handle to create a relatively permanent attachment of the handle apparatus to the target luggage. Other attachment means can be used, such as straps, buckles, pins, clasps, welds, glues, binding wire or other wire/rope-type materials. The attachment means can be of a permanent or quick release mechanism.

In one preferred embodiment, the handle structure is shaped to fit the human hand. The shaping of the handle structure can be of a permanent, manufactured shape. Also, such could be customized cast for the individual using the handle apparatus. Similarly, the handle structure can comprise formable material, for example a liquid, gel, foam or bead material. A preferred embodiment is a telescoping handle structure. Alternatively, the handle can be of a more permanent material, such as wood, metal, plastic, aluminum. In a preferred embodiment, a grip structure is a part of the handle and conveniently made of foam, rubber, cushioned material, and formed to the hand, different sizes or dimensions/lengths

The handle can be of any of a variety shapes, some utilitarian, other fanciful, such as a shape of “C”, “D”, “T”, or “O”.

The handle apparatus has means providing two or more degrees of freedom between the first structure and the handle structure. “Two or more degrees of freedom” describes the capability of the first structure to be rotated about at least two of the axis of a Cartesian system containing both the first structure and the handle structure. In one embodiment the degrees of freedom can be accomplished by use of a set of hinges which are configured in a non-parallel manner. In another embodiment the degrees of freedom can be accomplished by use of a hinge and means containing a ball and socket. One such ball and socket means is a handle structure hinged to a cantilever member extends ending in a spherical ball member. This ball member is positioned in a socket member that is attached to or monolithically formed with the first structure. Alternatively, the sequence of hinge member and ball and socket member can be reversed in a manner to achieve the same effect, which is the creation of a hinged, rotatable union allowing relative movement in two or more degrees of freedom. Non-limiting examples include a ball bearing, O-ring, ball and socket, quick release, and a ¼ turn locking/semi-locking system. Similarly, rotation can be about the axis of the existing handle cross-bar enabled by slippage between the existing handle cross-bar surface and the surface of the means of attachment, e. g. the surface of a strap.

While not being limited by the following examples, the present invention has versatility in having use with warehouse and shipping pallets and crates, wheeled luggage, wagons, wheeled and non wheeled ice chests, wheeled pull carts, child's wagon, golf carts, wheeled file cabinet carts, and wheeled fishing supply carts. Other examples include a variety of box or bulky shaped items being hauled, such as hay bales, strapped or tied items, haltered animals (e. g. bitted horses and seeing-eye dogs).

An alternative embodiment is to integrate the present system as a part of a luggage handle in a new luggage device by converting the attachment means into a permanent junction between the stem and the luggage directly and not on a fixed handle of the luggage device.

Among the benefits of use of the present invention is that it eases tension on arm muscles, lowers the weight load closer to the floor, helps give additional height to current handle for taller people causing, less stress from having to fight weight from almost vertical position, swivel/pivot allows you to hold handle completely, allowing freedom of, and movement while turning in any direction, even backing up.

One preferred embodiment is a handle assembly apparatus comprising a handle and an attachment means. The handle comprises a first handle half and a second handle half. When assembled, the first handle half and second handle half formed the handle and are connected so as to form a first cylinder portion containing a rim and a first aperture. The attachment means comprises a second cylinder portion. This second cylinder portion has a step-down portion and a second aperture. The attachment means also contains a flexible strap means, preferably a Velcro strap, suitable to connect to an existing handle.

The attachment means, preferably a bolt and nut assembly, passes through said first and second apertures. The step-down portion fits within the rim of the first cylinder portion. The assembly means, step-down portion and attachment means act cooperatively to enable the handle to rotate relative to the attachment means. The cooperative engagement acts to maintain a bias of the handle against the attachment means.

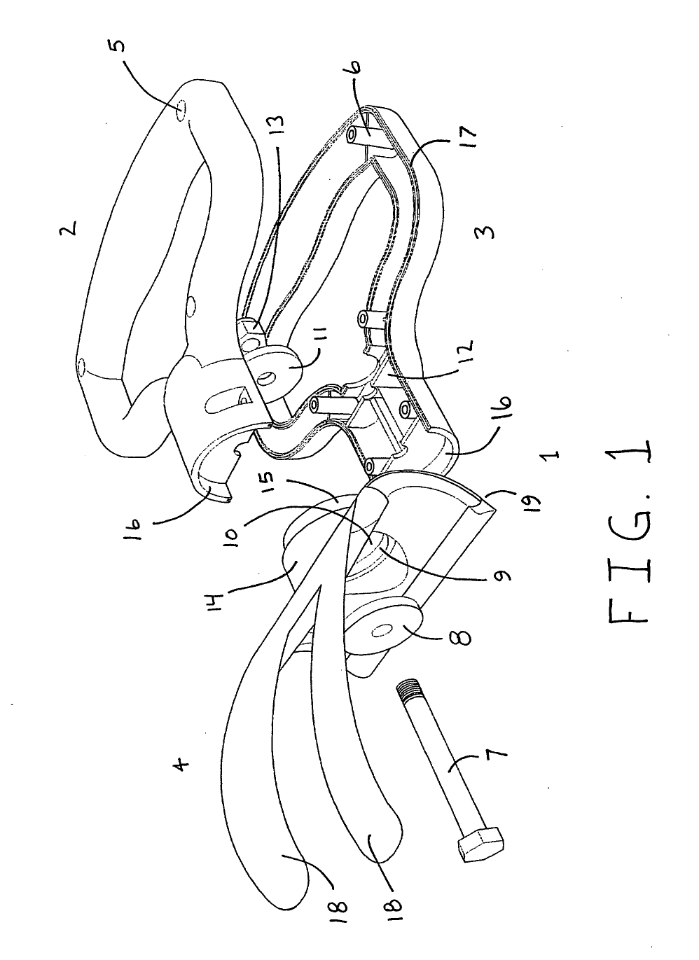

In FIG. 1 there is depicted an exploded view of another preferred embodiment of the present invention. Handle assembly 1 is composed of three major components: a first handle half 2, a second handle half 3, and an attachment means 4. There is a bolt 7 which in assembly passes through washer 8. When the handle 1 is assembled, washer 8 is biased against rim 9, which rim 9 forms an aperture 10. Bolt 7 in assembly passes through aperture 10 and washer 11. When handle assembly 1 is assembled, washer 11 is biased against wall 12. First handle half 2 contains a similar wall not shown, so that when fitted to second handle half 3 forms an aperture through which bolt 7 passes before passing through washer 11. Nut 13 in assembly is attached to bolt 7. In assembly, the threading of bolt 7 and nut 13 allows the step-down rim 15 of extended cylinder 14 of attachment means 4 to fit inside rims 16 which forms a cylindrical rim when first and second handle halves 2 and 3 are fitted together in assembly. The connection of bolt 7 and nut 13 is such that the handle formed by the joining of first and second handle halves 2 and 3 is free to rotate relative to attachment means 4 via slippage between step-down portion 15 and rims 16. In assembly channel slot 17 of the second handle half 3 receives an extended rim (unnumbered and unseen) on first handle half 2 to assist in alignment and strength in the connection of the two halves. In use straps 18 is looped around an existing luggage handle and connected to collar surface 19 of the attachments means 4 by any convenient mechanism, such as, but not limited to, Velcro material, snaps or other known connecting mechanism. Preferably, straps 18 are not secured so tightly so that rotating of the handle assembly 1 about the existing handle is possible. Accordingly, in use handle assembly 1 can have multiple degrees of rotation relative to an existing handle to which it is attached.

An optional feature is to provide extender devices to lengthen the handle. This would entail providing a device (not shown in the drawing) having the same or similar cross-section as extended cylinder 14 with the configuration of step-down portion 15 at one end, e. g., unshown step-down portion 15′, and rim 16 at the other end, e. g., unshown rim 16′. The optional extender could be used by inserting step-down portion 15′ into rim 16, and inserting step-down portion 15 into rim 16′. Similarlt, a number of such extenders could also be provided. The length and number of such extender devices are a matter of choice, but the length of bolt 7 would have to be adjusted accordingly.

What is claimed is:

1. A handle apparatus comprising
(a) a first structure comprising attachment means to attach said handle apparatus to a subject device;
(b) a handle structure; and
(c) a second structure communicating between said first structure and said handle structure, said second structure having means providing two or more degrees of freedom between said first structure and said handle structure.

2. The handle apparatus of claim 1 wherein said first structure comprises an elongated member with two ends and said attachment means are located proximal to each end and are effective to attach said handle apparatus to another handle.

3. The handle apparatus of claim 2 wherein said attachment means are straps.

4. The handle apparatus of claim 2 wherein said attachment means are pins.

5. The handle apparatus of claim 1 wherein said handle structure is shaped to fit the human hand.

6. The handle apparatus of claim 1 wherein said handle structure comprises formable material.

7. The handle apparatus of claim 1 wherein said means providing two or more degrees of freedom between said first structure and said handle structure comprises one or more hinges.

8. The handle apparatus of claim 7 wherein said handle structure comprises two hinges.

9. The handle apparatus of claim 7 wherein said handle structure comprises one or more hinges and a rotatable union.

10. A handle assembly apparatus comprising
a handle comprising a first handle half and a second handle half, said first handle half and second handle half being formed and connected so as to form a first cylinder portion comprising a rim and an aperture, and
an attachment means comprising a second cylinder portion comprising a step-down portion, a second aperture, and flexible strap means suitable to connect to an existing handle,
wherein an attachment means passes through said first and second apertures and said step-down portion fits with said rim of said first cylinder portion, said assembly means, said step-down portion and said attachment means acting cooperatively to permit said handle to rotate relative to said attachment means and acting to maintain the bias said handle against said attachment means.

11. The apparatus of claims 10 wherein said attachment means is a bolt and nut assembly.
